(19) United States
(12) Patent Application Publication
(10) Pub. No.: US 2026/0154163 A1
(43) Pub. Date: Jun. 4, 2026

(54) METHOD AND RELATED APPARATUS FOR DATA BACKUP OF MULTI-CONTROLLER

(71) Applicant: SUZHOU METABRAIN INTELLIGENT TECHNOLOGY CO., LTD., Suzhou, Jiangsu (CN)

(72) Inventors: Lupan WANG, Suzhou, Jiangsu (CN); Ji ZHONG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/122,328

(22) PCT Filed: May 26, 2023
(86) PCT No.: PCT/CN2023/096461

§ 371 Date: Apr. 18, 2025

(30) Foreign Application Priority Data
Nov. 29, 2022 (CN) 202211508014.5

(51) Int. Cl. G06F 11/1446; G06F 9/50

(52) U.S. Cl. CPC G06F 11/1458; G06F 9/5038; G06F 2209/503

(57) ABSTRACT

A method and apparatus for data backup of multi-controller, a storage control system, a terminal device, and a computer non-transitory readable storage medium. The method includes: acquiring a processor working state of a host end; performing task volume evaluation calculation on each storage controller based on the processor working state, to obtain a task volume of each storage controller, wherein the number of all the storage controllers is greater than two, and two common NTB channel chips for unidirectional transmission are connected between all the storage controllers; determining a corresponding data backup task volume of each storage controller based on the task volume of each storage controller and a data processing task volume of each storage controller; and executing a backup task on corresponding storage controllers via the common NTB channel chips and the data backup task volume of each storage controller.

### CROSS-REFERENCE TO RELATED APPLICATION

The present disclosure claims the priority of Chinese Patent Application 202211508014.5, filed in the China Patent Office on Nov. 29, 2022, and entitled “Method and Related Apparatus for Data Backup of Multi-Controller”, the entire contents of which are herein incorporated by reference.

### TECHNICAL FIELD

The present disclosure relates to the technical field of computers, and in particular to a method for data backup of multi-controller, a storage control system, an apparatus for data backup, a terminal device, and a computer non-transitory readable storage medium.

### BACKGROUND

In the related art, the data backup process is data interaction between every two controllers, and this process requires an independent NTB (Non-Transparent Bridging) chip for on-hardware cascading. For devices such as multi-controller storage and server, this data backup mode requires a large number of NTB chips, which increases the system cost; and moreover, since the double controllers back up data for each other, when one controller is abnormal, the data backup process is terminated. Therefore, this traditional data backup process will not only increase the design cost, but also result in a data backup failure at an abnormal moment, leading to a reduction in the working reliability of storage devices and affecting the use of users.

### SUMMARY

According to a first aspect, the present disclosure provides a method for data backup of multi-controller, including:
acquiring a processor working state of a host end;
performing task volume evaluation calculation on each storage controller based on the processor working state, to obtain a task volume of each storage controller, wherein the number of all the storage controllers is greater than two, and two common NTB channel chips for unidirectional transmission are connected between all the storage controllers;
determining a corresponding data backup task volume of each storage controller based on the task volume of each storage controller and a data processing task volume of each storage controller; and
executing a backup task on corresponding storage controllers via the common NTB channel chips and the data backup task volume of each storage controller.

In some embodiments of the present disclosure, performing task volume evaluation calculation on each storage controller based on the processor working state, to obtain the task volume of each storage controller includes:
performing weighted balance calculation on each storage controller based on the processor working state, to obtain the task volume of each storage controller.

In some embodiments of the present disclosure, performing weighted balance calculation on each storage controller based on the processor working state, to obtain the task volume of each storage controller includes:
determining parameters of data processing at a next time node based on the processor working state, wherein the parameters include a data volume, a data type, a data use, and a storage address; and
using the data type, the data use and the storage address as weights, using the data volume as the parameter of each weight, and performing weighted calculation to obtain the task volume of each storage controller.

In some embodiments of the present disclosure, the method further includes:
when the task volume of each storage controller is obtained, respectively sorting the task volumes of the storage controllers on left and right ends of the common NTB channel chips.

In some embodiments of the present disclosure, determining the corresponding data backup task volume of each storage controller based on the task volume of each storage controller and the data processing task volume of each storage controller includes:
controlling a storage controller having the maximum task volume on the left end of the common NTB channel chip to issue a data backup task to a storage controller having the minimum task volume on the right end of the common NTB channel chip, and so on; and
controlling a storage controller having the minimum task volume on the left end of the common NTB channel chip to issue the data backup task to a storage controller having the maximum task volume on the right end of the common NTB channel chip, and so on.

In some embodiments of the present disclosure, the method further includes:
when executing a data processing task and the data backup task, recording servers of the data processing task and the data backup task to obtain log data, and saving the log data.

In some embodiments of the present disclosure, all the storage controllers are divided into left half-region storage controllers and right half-region storage controllers, and the two common NTB channel chips for unidirectional transmission include an upper common NTB channel chip and a lower common NTB channel chip.

In some embodiments of the present disclosure, a PCIE transport channel on each left half-region storage controller is connected with the upper common NTB channel chip for transporting data, and a PCIE receive channel on each right half-region storage controller is connected with the upper common NTB channel chip for receiving data; and the PCIE receive channel on each left half-region storage controller is connected with the lower common NTB channel chip for receiving data, and the PCIE transport channel on each right half-region storage controller is connected with the lower common NTB channel chip for transporting data.

In some embodiments of the present disclosure, executing the backup task on the corresponding storage controllers via the common NTB channel chips and the data backup task volume of each storage controller includes:

respectively executing the backup task on the left half-region storage controllers and the right half-region storage controllers via the upper common NTB channel chip and the lower common NTB channel chip.

In some embodiments of the present disclosure, the method further includes:
when one or more storage controllers are abnormal, performing fault analysis to obtain data processing tasks to be allocated and data backup tasks to be allocated; and
allocating the data processing tasks to be allocated and the data backup tasks to be allocated to other storage controllers.

In some embodiments of the present disclosure, when one or more storage controllers are abnormal, performing fault analysis to obtain the data processing tasks to be allocated and the data backup tasks to be allocated includes:
when one or more storage controllers are abnormal, performing data feature extraction to obtain data features; and
performing fault analysis based on the data features to obtain the data processing tasks to be allocated and the data backup tasks to be allocated.

In some embodiments of the present disclosure, allocating the data processing tasks to be allocated and the data backup tasks to be allocated to the other storage controllers includes:
performing priority analysis on each data processing task to be allocated and each data backup task to be allocated, to obtain a priority of each task; and
allocating the data processing tasks to be allocated and the data backup tasks to be allocated to the other storage controllers based on the priority of each task.

In some embodiments of the present disclosure, the method further includes:
recording fault information and task allocation situation information in a log manner.

According to a second aspect, the present disclosure further provides a method for data backup of multi-controller, including:
acquiring a processor working state of a host end;
determining a task volume of each storage controller based on the processor working state, wherein number of the storage controllers is greater than two, and two common NTB channel chips for unidirectional transmission are connected between all storage controllers;
determining a data backup task volume corresponding to each storage controller based on the task volume of each storage controller and a data processing task volume of each storage controller; and
executing a backup task on the storage controllers according to a determined data backup task volume of each storage controller.

According to a third aspect, the present disclosure further provides a storage control system, including: a plurality of storage controllers, two common NTB channel chips, and a hard disk,
wherein each common NTB channel chip is connected with a data channel of each storage controller, and each storage controller is connected with the hard disk; and
the common NTB channel chip is configured to, along with a data backup task volume of each storage controller, execute a backup task on corresponding storage controllers.

In some embodiments of the present disclosure, there are even numbers of storage controllers, and the plurality of storage controllers include left half-region storage controllers and right half-region storage controllers.

In some embodiments of the present disclosure, the common NTB channel chips for two unidirectional transmission include an upper common NTB channel chip and a lower common NTB channel chip.

In some embodiments of the present disclosure, a PCIE transport channel on the left half-region storage controller is connected with the upper common NTB channel chip for transporting data, and a PCIE receive channel on the right half-region storage controller is connected with the upper common NTB channel chip for receiving data; and the PCIE receive channel on the left half-region storage controller is connected with the lower common NTB channel chip for receiving data, and the PCIE transport channel on the right half-region storage controller is connected with the lower common NTB channel chip for transporting data.

In some embodiments of the present disclosure, the upper common NTB channel chip executes the backup task on the left half-region storage controllers and the right half-region storage controllers; and
the lower common NTB channel chip executes the backup task on the left half-region storage controllers and the right half-region storage controllers.

According to a fourth aspect, the present disclosure further provides an apparatus for data backup of multi-controller, including:
a working state acquisition module, configured to acquire a processor working state of a host end;
a task volume evaluation module, configured to perform task volume evaluation calculation on each storage controller based on the processor working state, to obtain a task volume of each storage controller, wherein the number of all the storage controllers is greater than two, and two common NTB channel chips for unidirectional transmission are connected between all the storage controllers;
a task volume balancing module, configured to determine a corresponding data backup task volume of each storage controller based on the task volume of each storage controller and a data processing task volume of each storage controller; and
a backup task execution module, configured to execute a backup task on corresponding storage controllers via the common NTB channel chips and the data backup task volume of each storage controller.

According to a fifth aspect, the present disclosure further provides a terminal device, including:
a memory, configured to store a computer program; and
a processor, configured to implement the steps of the above method for data backup of multi-controller when executing the computer program.

According to a sixth aspect, the present disclosure further provides a computer non-transitory readable storage medium, wherein a computer program is stored on the computer non-transitory readable storage medium, and the computer program, when executed by a processor, implements the steps of the above method for data backup of multi-controller.

### BRIEF DESCRIPTION OF THE DRAWINGS

To illustrate technical solutions in the embodiments of the present disclosure or in the prior art more clearly, a brief introduction on the drawings which are needed in the description of the embodiments or the prior art is given below. Apparently, the drawings in the description below are merely some embodiments of the present disclosure, based on which other drawings may be obtained by those ordinary skilled in the art without any creative effort.

FIG. 1 is a flowchart of a method for data backup of multi-controller provided in some embodiments of the present disclosure;

FIG. 2 is a schematic structural diagram of a method for data backup of multi-controller provided in some embodiments of the present disclosure;

FIG. 3 is a flowchart of a data backup algorithm provided in some embodiments of the present disclosure;

FIG. 4 is a flowchart of abnormality processing of a method for data backup of multi-controller provided in some embodiments of the present disclosure;

FIG. 5 is a schematic structural diagram of an apparatus for data backup of multi-controller provided in some embodiments of the present disclosure; and

FIG. 6 is a schematic structural diagram of a terminal device provided in some embodiments of the present disclosure.

### DETAILED DESCRIPTION OF THE EMBODIMENTS

The core of the present disclosure is to provide a method for data backup of multi-controller, a storage control system, an apparatus for data backup, a terminal device, and a computer non-transitory readable storage medium, so as to improve the backup efficiency and reduce the hardware cost under the application of double NTB chips.

In order to make the objectives, technical solutions and advantages of the embodiments of the present disclosure clearer, a clear and complete description of technical solutions in the embodiments of the present disclosure will be given below, in combination with the drawings in the embodiments of the present disclosure. Apparently, the embodiments described below are merely a part, but not all, of the embodiments of the present disclosure. All of other embodiments, obtained by those ordinary skilled in the art based on the embodiments in the present disclosure without any creative effort, fall into the protection scope of the present disclosure.

With the continuous development of information technology, higher requirements have been put forward for the reliability of storage arrays, especially for the stability and reliability of data backup in storage systems; in a current architecture design of the storage system, pairwise data backup between double controllers is implemented by an NTB (Non-Transparent Bridging) chip to ensure that a data backup process is terminated when current data is simultaneously stored in memories of the two controllers.

In the related art, a data backup process is data interaction between every two controllers, and this process requires an independent NTB chip for on-hardware cascading. For devices such as multi-controller storage and server, this data backup mode requires a large number of NTB chips, which increases the system cost; and moreover, since the double controllers back up data for each other, when one controller is abnormal, the data backup process is terminated. Therefore, this traditional data backup process will not only increase the design cost, but also result in a data backup failure at an abnormal moment, leading to a reduction in the working reliability of storage devices and affecting the use of users.

Therefore, how to improve the effect of applying the NTB chip in the data backup process of the multi-controller storage and server devices to improve the backup efficiency is a key problem to which those skilled in the art pay attention.

Therefore, embodiments of the present disclosure provide a method for data backup of multi-controller. By means of first acquiring a processor working state of a host end, then determining a processable task volume of each storage controller based on the processor working state, determining a corresponding data backup task volume based on the task volume, and finally executing a backup task according to the determined data backup task volume, in a case where there are two NTB channel chips, the task volume of each storage controller is balanced, data backup is realized, and the efficiency of data backup is improved while the hardware cost is reduced.

A method for data backup of multi-controller provided in some embodiments of the present disclosure will be described below through one embodiment.

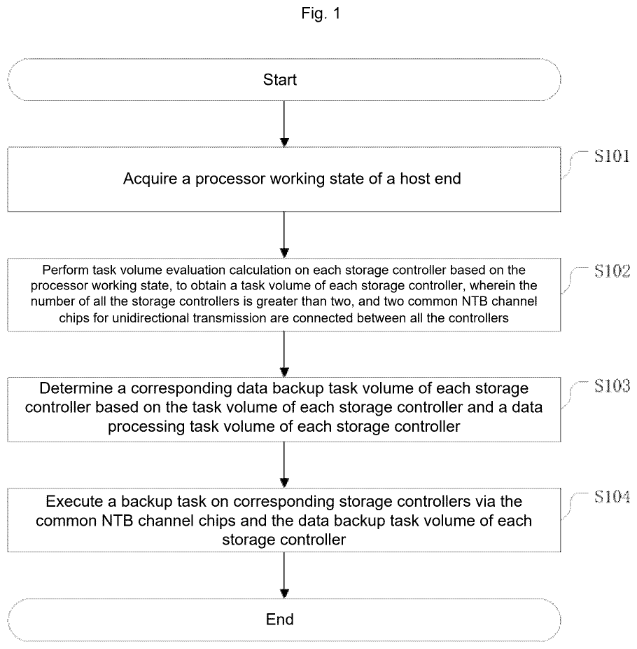

Referring to FIG. 1, FIG. 1 is a flowchart of a method for data backup of multi-controller provided in some embodiments of the present disclosure.

In some embodiments of the present disclosure, the method may include:
S101, acquiring a processor working state of a host end.

The present step is intended to determine the processor working state of the host end, so as to determine a processable task volume via the processor working state.

In some embodiments of the present disclosure, only two NTB chips are used in a corresponding hardware structure in some embodiments of the present disclosure, so as to reduce the hardware cost. Therefore, all storage controllers are divided into left half-region storage controllers and right half-region storage controllers, and the two common NTB channel chips for unidirectional transmission include an upper common NTB channel chip and a lower common NTB channel chip; and
a PCIE transport channel on the left half-region storage controller is connected with the upper common NTB channel chip for transporting data, and a PCIE receive channel on the right half-region storage controller is connected with the upper common NTB channel chip for receiving data; and the PCIE receive channel on the left half-region storage controller is connected with the lower common NTB channel chip for receiving data, and the PCIE transport channel on the right half-region storage controller is connected with the lower common NTB channel chip for transporting data.

S102, performing task volume evaluation calculation on each storage controller based on the processor working state, to obtain a task volume of each storage controller, wherein the number of all the storage controllers is greater than two, and two common NTB channel chips for unidirectional transmission are connected between all the storage controllers.

On the basis of S101, the present step is intended to perform task volume evaluation calculation on each storage controller based on the processor working state, to obtain the task volume of each storage controller, wherein the number of all the storage controllers is greater than two, and the two common NTB channel chips for unidirectional transmission are connected between all the controllers.

In some embodiments of the present disclosure, the present step may include:
performing weighted balance calculation on each storage controller based on the processor working state, to obtain the task volume of each storage controller.

It may be seen that the present alternative solution mainly describes how to determine the task volume. In the present alternative solution, the weighted balance calculation is performed on each storage controller based on the processor working state to obtain the task volume of each storage controller.

In some embodiments of the present disclosure, the previous alternative solution may include:
step 1, determining parameters of data processing at a next time node based on the processor working state, wherein the parameters include a data volume, a data type, a data use, and a storage address; and
step 2, using the data type, the data use and the storage address as weights, using the data volume as the parameter of each weight, and performing weighted calculation to obtain the task volume of each storage controller.

It may be seen that the present alternative solution mainly describes how to determine a corresponding task volume. In the present alternative solution, the parameters of data processing at the next time node are determined based on the processor working state, wherein the parameters include the data volume, the data type, the data use, and the storage address; and the data type, the data use and the storage address are used as weights, the data volume is used as the parameter of each weight, and weighted calculation is performed to obtain the task volume of each storage controller.

In addition, the previous alternative solution may further include:
when the task volume of each storage controller is obtained, respectively sorting the task volumes of the storage controllers on left and right ends of the common NTB channel chips.

S103, determining a corresponding data backup task volume of each storage controller based on the task volume of each storage controller and a data processing task volume of each storage controller.

On the basis of S102, the present step is intended to determine the corresponding data backup task volume of each storage controller based on the task volume of each storage controller and the data processing task volume of each storage controller.

In some embodiments of the present disclosure, the present step may include:
step 1, controlling a storage controller having the maximum task volume on the left end of the common NTB channel chip to issue a data backup task to a storage controller having the minimum task volume on the right end of the common NTB channel chip, and so on; and
step 2, controlling a storage controller having the minimum task volume on the left end of the common NTB channel chip to issue the data backup task to a storage controller having the maximum task volume on the right end of the common NTB channel chip, and so on.

It may be seen that the present alternative solution mainly describes how to allocate different task volumes to the storage controllers. In the present alternative solution, the controller having the maximum task volume on the left end of the common NTB channel chip is controlled to issue the data backup task to the controller having the minimum task volume on the right end of the common NTB channel chip, and so on; and the controller having the minimum task volume on the left end of the common NTB channel chip is controlled to issue the data backup task to the controller having the maximum task volume on the right end of the common NTB channel chip, and so on.

In addition, embodiments of the present disclosure may further include:
when executing a data processing task and the data backup task, recording servers of the data processing task and the data backup task to obtain log data, and saving the log data.

S104, executing a backup task on corresponding storage controllers via the common NTB channel chips and the data backup task volume of each storage controller.

On the basis of S103, the present step is intended to execute the backup task on the corresponding storage controllers via the common NTB channel chips and the data backup task volume of each storage controller.

In some embodiments of the present disclosure, the present step may include:
respectively executing the backup task on the left half-region storage controllers and the right half-region storage controllers via the upper common NTB channel chip and the lower common NTB channel chip.

In addition, the embodiment of the present disclosure may further include:
step 1, when one or more storage controllers are abnormal, performing fault analysis to obtain data processing tasks to be allocated and data backup tasks to be allocated; and
step 2, allocating the data processing tasks to be allocated and the data backup tasks to be allocated to other storage controllers.

It may be seen that the present alternative solution mainly describes how to process abnormality when the same occurs. In the present alternative solution, when one or more storage controllers are abnormal, fault analysis is performed to obtain the data processing tasks to be allocated and the data backup tasks to be allocated, and the data processing tasks to be allocated and the data backup tasks to be allocated are allocated to the other storage controllers.

In some embodiments of the present disclosure, the step 1 in the previous alternative solution may include:
step 1.1, when one or more storage controllers are abnormal, performing data feature extraction to obtain data features; and
step 1.2, performing fault analysis based on the data features to obtain the data processing tasks to be allocated and the data backup tasks to be allocated.

It may be seen that the present alternative solution mainly describes how to perform task allocation when abnormality occurs. In the present alternative solution, when one or more storage controllers are abnormal, data feature extraction is performed to obtain the data features, and fault analysis is performed based on the data features to obtain the data processing tasks to be allocated and the data backup tasks to be allocated.

In some embodiments of the present disclosure, the step 2 in the previous alternative solution may include:
step 2.1, performing priority analysis on each data processing task to be allocated and each data backup task to be allocated, to obtain a priority of each task; and
step 2.2, allocating the data processing tasks to be allocated and the data backup tasks to be allocated to the other storage controllers based on the priority of each task.

It may be seen that the present alternative solution mainly describes how to improve the task allocation effect. In the present alternative solution, priority analysis is performed on each data processing task to be allocated and each data backup task to be allocated, to obtain the priority of each task, and the data processing tasks to be allocated and the data backup tasks to be allocated are allocated to the other storage controllers based on the priority of each task.

In some embodiments of the present disclosure, the previous alternative solution may further include:
recording fault information and task allocation situation information in a log manner.

In conclusion, in the embodiment of the present disclosure, by means of first acquiring the processor working state of the host end, then determining the processable task volume of each storage controller based on the processor working state, determining the corresponding data backup task volume based on the task volume, and finally executing the backup task according to the determined data backup task volume, in a case where there are two NTB channel chips, the task volume of each storage controller is balanced, data backup is realized, and the efficiency of data backup is improved while the hardware cost is reduced.

A method for data backup of multi-controller provided in some embodiments of the present disclosure will be described below through another embodiment.

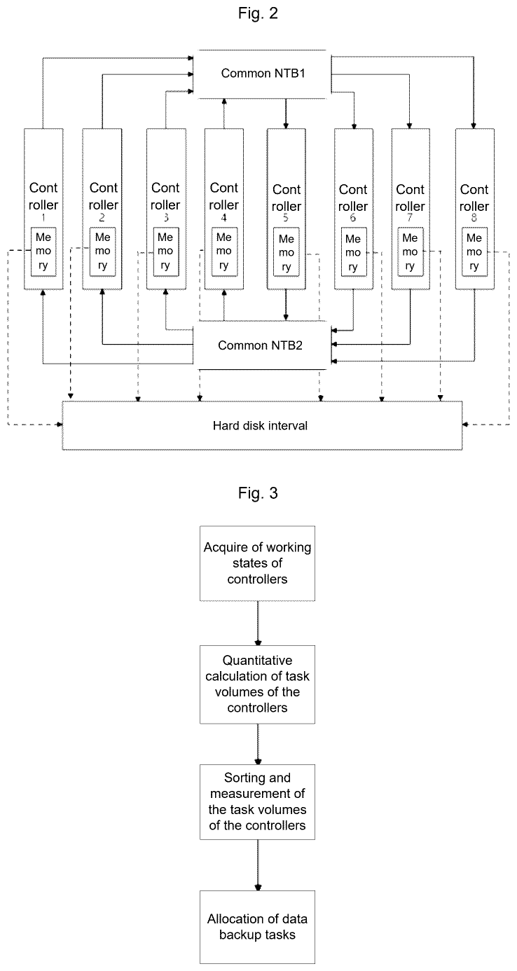

Referring to FIG. 2, FIG. 2 is a schematic structural diagram of a method for data backup of multi-controller provided in some embodiments of the present disclosure.

In some embodiments of the present disclosure, a corresponding system structure topology provided is shown in FIG. 2, core devices in the topology are an upper common NTB channel chip and a lower common NTB channel chip, the two common NTB channel chips divide multi-controller into a left half region and a right half region, since storage devices require data backup, there are even number of controllers in general, and the controllers in the two half regions are configured with the same number and may back up data for each other. A PECI (peripheral component interconnect express) transport (Tx) channel on the controller on the left side is connected with the upper common NTB channel chip for transporting data, and a PCIE receive (Rx) channel on the controller on the right side is connected with the upper common NTB channel chip for receiving data; and similarly, the PCIE receive (Rx) channel on the controller on the left side is connected with the lower common NTB channel chip for receiving data, and the PCIE transport (Tx) channel on the controller on the right side is connected with the upper common NTB channel chip for transporting data. The controller includes a memory bank, during the process of processing data by the controller, the data is first stored in a memory, backup data is also stored in the memory of the corresponding controller, a rear end of the controller is connected with a hard disk, and after processing and backup operations of the data are completed, the data is transmitted into the hard disk.

In some embodiments of the present disclosure, taking an eight-controller storage device as an example, an NTB chip PEX8733 is used, the chip includes 42 input and output channels, the eight-controller storage device is provided with four controllers on each end of an NTB channel, the 42 channels are equally allocated to the four controller, and 10 channels are allocated to each controller. Therefore, the upper common NTB allocates 10 channels to the four controllers on the left side to serve as data transport (Tx) PCIE channels, and allocates 10 channels to the four controllers on the right side to serve as data receive (Rx) PCIE channels; and the lower common NTB allocates 10 channels to the four controllers on the left side to serve as the data receive (Rx) PCIE channels, and allocates 10 channels to the four controllers on the right side to serve as the data transport (Tx) PCIE channels. In terms of firmware, an NTx (multi-transport channel) port of the NTB chip is configured to be mapped to a plurality of target devices by using a direct address conversion mode of the PEX8733 NTB chip, and the plurality of target devices are multiple controllers on the other side of the NTB, such a configuration ensures that a data packet processed by the controllers on one side of an NTB may be converted by the NTB onto a plurality of controllers on the other side of which the device addresses have been configured, thereby ensuring the implementability of backing up data to multiple controllers.

Referring to FIG. 3, FIG. 3 is a flowchart of a data backup algorithm provided in some embodiments of the present disclosure.

Embodiments of the present disclosure provides a double-common NTB storage data management flow algorithm matching the topology structure in terms of algorithm, and the flowchart of the algorithm is shown in FIG. 3 when the system works normally: when the storage device works normally, a CPU on a mainboard of the storage controller serves as a multi-core processor, which may simultaneously process and analyze multi-channel data transmitted by a HOST end of a server, and data volumes, data types, data uses, storage addresses and the like processed in the CPUs of the multiple controllers are widely divergent at a same moment, therefore data sharing among the multiple controllers is realized by common NTB channels, and the basis of the transmission data sharing is state sharing among the controllers.

Therefore, the algorithm flow may include:

Step 1, acquiring a working state of a CPU under a data task transmitted by a current Host end.

Step 2, after considering own data processing task volumes of multiple controllers according to the working state of the CPU at this time, expressing the magnitude of the task volume of each controller in a quantitative manner, which is the core of the algorithm flow. Considering that data parameters transmitted from the HOST end to the storage device are different in a data processing process, when a data processing backup state is planned, a weighted balance algorithm is used to stabilize the workload of a planned processor. The object of a weighting process is data to be transmitted and processed by the processor at the next time node, each weighting item in the weighting process is a parameter of the processed data, the parameters include four items, that is, a data volume, a data type, a data use and a storage address, the data volume is used as a basic unit for statistics and is denoted as Q, and then the three parameters, that is, the data type, the data use and the storage address, are respectively quantized into corresponding weight values. In a quantization process, specific situations of the above three weight parameters are list at first, wherein the storage address is an address of storing the data to a corresponding SSD, disk storage addresses required for this data are divided into three types, that is, near, middle and far, an SSD adjacent to the controller is denoted as a near-end address and the weight thereof is denoted as 1, and the weight of a middle-end address and the weight of a far-end address are both higher than 1, which are increased according to actual application situations and are denoted as a1; the data type includes the most basic plain text data txt, graphic data gif, file tar, and the like, and each type of data is weighted according to the complexity of the processing capacity of the server, wherein the weight of the plain text data is 1, and the weights of the rest types of data are higher than 1 and are denoted as a2; and the data in the server is divided into four types, that is, metadata, system data, reference data and transaction data, the weight of the metadata is also denoted as 1, the weights of the remaining types of data are weighted according to actual situations and are denoted as a3. In this way, the weights of the three weight parameters are respectively denoted as a1, a2 and 3, corresponding to the weights, it is assumed that a data volume required for processing the three weight parameters on one controller is Q, based on the above example analysis, the present disclosure provides a formula for measuring the workload G of the storage controller, which is as follows:

$$G = a 1 * Q + a 2 * Q + a 3 * Q$$

wherein the formula represents the sum of products of the three weight parameters and respective corresponding data volumes, the weight parameters are respectively a1, a2 and a3, each part of the formula is not simply multiplied, taking a1 multiplying by Q as an example, Q is a total data volume processed in the current stage, different parts in the data volume may include data of different addresses, therefore, a1 multiplying by Q means the sum of a product of each part of data volume in Q and the weight of an address corresponding to this part of data volume; and similarly, a2 multiplying by Q means the sum of a product of each part of data volume in Q and the weight of the data type corresponding to this part of data volume, and a3 multiplying by Q means the sum of a product of each part of data volume in Q and the weight of the data use corresponding to this part of data volume. After the workload G of each storage controller is calculated according to the formula, G on the left and right ends of the NTB are sorted to obtain a workload ranking of the controllers on the left and right ends.

Step 3, after the workload of the controller is measured, allocating a data backup task, wherein a workload required for data backup is consistent with a workload required for processing the current data, therefore in a backup process, the controller having the maximum data processing task volume on the left end of the NTB backup the data to a controller having the minimum data processing task volume on the right end of the NTB, and so on; and the controller having the minimum data processing task volume on the left end of the NTB backup the data to a controller having the maximum data processing task volume on the right end of the NTB, and so on. By means of this backup mode, it may be ensured that the sum of task volumes of “data processing+data backup” on each controller reaches a balanced state, which makes the controller process data more efficient, the data processing time of each controller is also close, therefore within a similar time, each controller efficiently completes data processing and backup tasks at the same time. In addition, during the data processing and backup process of the controller, it is necessary to record the data processing and backup servers in the current stage and save same in a log manner, so as to ensure that there is no confusion in a subsequent process of downloading the data from the disk.

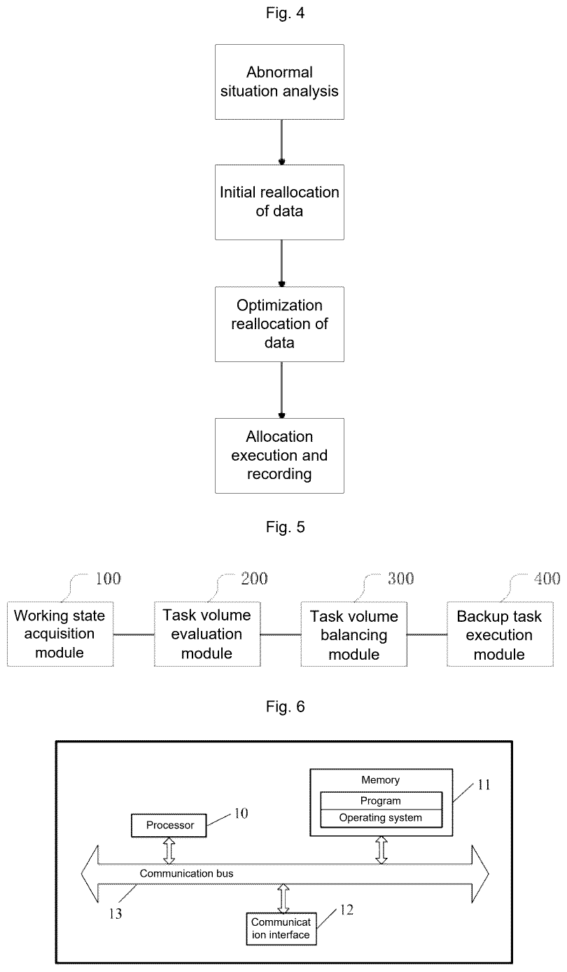

Referring to FIG. 4, FIG. 4 is a flowchart of abnormality processing of a method for data backup of multi-controller provided in some embodiments of the present disclosure.

When one or more controllers in the system are abnormal, the flowchart of the algorithm is as shown in FIG. 4: firstly, analyzing the abnormal situation to obtain the influence of a fault (data processing and backup tasks borne by the controller crash) of the controller at the current moment on the entire system, and analyzing data processing and data backup situations in the controller, wherein the data processing and data backup tasks of the controller need to be allocated to other processors. The analysis process includes extraction and analysis of data features, and the data processed by the controller is divided into three importance levels, that is, high, medium and low, and the importance level of the data determines the sequence of processing and backup processes; after the analysis is completed, reallocation planning is performed on the data processing tasks based on the idea of the balance algorithm, so as to ensure that the tasks borne by the abnormal controller may be effectively allocated to the remaining normally working controllers, and the reallocation planning is divided into initial reallocation and optimization reallocation, so as to ensure that a data transmission task is smoothly performed within a short time through rapid initial reallocation without affecting the normal operation of the system, the initial reallocation is to perform adjacent backup on data with a high importance level, a front end of the server hands over data processed in the controller and data to be backed up to two adjacent controllers for urgent processing, so as to ensure that important data is not lost; the optimization reallocation is to perform secondary allocation during operation based on the initial allocation, so as to avoid problems such as workload overload of the CPU caused by uneven allocation of the data processing tasks on the controller; and reallocation is to re-sort the workload tasks of the controller according to the previously provided workload measurement method (the workloads of the two adjacent controllers of the abnormal controller will relatively increase at this time), after the sorting is completed, the data with the medium importance level and the data with the low importance level are allocated to two controllers with the minimum workload for processing, and the problems and reallocation situations will be recorded in the log manner.

It may be seen that, according to a double-common NTB-based multi-controller storage device optimization method and topology in some embodiments of the present disclosure, the data transmission function of the common NTB may be fully utilized in a topology process, and a common data transmission channel is provided between multiple controllers. Therefore, on one hand, it is possible to reduce the number of NTBs and abandon the traditional approach of using NTBs between every two of the multiple controllers in previous studies, thus greatly reducing the design cost; and on the other hand, data transmission and backup reliability may be ensured by interconnecting the multiple controllers via the common NTB, and when one or more controllers are abnormal, other controllers may share the data processing task of the controller, thereby improving the data backup reliability, and reducing the risk of data packet loss. In addition, the matched data management algorithm provided in the present disclosure may improve the data transmission and backup efficiency between the controllers, ensure the working balance between the controllers, and give full play to the data transmission function of the NTB; and the data redistribution algorithm at the abnormal moment may also effectively ensure that the data backup is not interrupted when abnormality occurs, and the data on the abnormal controller may be backed up by normal controllers, thereby ensuring the security and reliability of the storage device, and reducing the cost loss caused by the loss of user data at the time of abnormality.

In some embodiments of the present disclosure, by means of first acquiring the processor working state of the host end, then determining the processable task volume of each storage controller based on the processor working state, determining the corresponding data backup task volume based on the task volume, and finally executing the backup task according to the determined data backup task volume, in a case where there are two NTB channel chips, the task volume of each storage controller is balanced, data backup is realized, and the efficiency of data backup is improved while the hardware cost is reduced.

An apparatus for data backup of multi-controller provided in some embodiments of the present disclosure will be described below, and the apparatus for data backup of multi-controller described below and the method for data backup of multi-controller described above may refer to each other.

Referring to FIG. 5, FIG. 5 is a schematic structural diagram of an apparatus for data backup of multi-controller provided in some embodiments of the present disclosure.

In some embodiments of the present disclosure, the apparatus may include:
a working state acquisition module 100, configured to acquire a processor working state of a host end;
a task volume evaluation module 200, configured to perform task volume evaluation calculation on each storage controller based on the processor working state, to obtain a task volume of each storage controller, wherein the number of all the storage controllers is greater than two, and two common NTB channel chips for unidirectional transmission are connected between all the storage controllers;
a task volume balancing module 300, configured to determine a corresponding data backup task volume of each storage controller based on the task volume of each storage controller and a data processing task volume of each storage controller; and
a backup task execution module 400, configured to execute a backup task on corresponding storage controllers via the common NTB channel chips and the data backup task volume of each storage controller.

In some embodiments of the present disclosure, the task volume evaluation module 200 is configured to perform weighted balance calculation on each storage controller based on the processor working state, to obtain the task volume of each storage controller.

In some embodiments of the present disclosure, the task volume evaluation module 200 is configured to determine parameters of data processing at a next time node based on the processor working state, wherein the parameters include a data volume, a data type, a data use, and a storage address; and use the data type, the data use and the storage address as weights, use the data volume as the parameter of each weight, and perform weighted calculation to obtain the task volume of each storage controller.

In some embodiments of the present disclosure, the task volume balancing module 300 is configured to control a storage controller having the maximum task volume on the left end of the common NTB channel chip to issue a data backup task to a storage controller having the minimum task volume on the right end of the common NTB channel chip, and so on; and control a storage controller having the minimum task volume on the left end of the common NTB channel chip to issue the data backup task to a storage controller having the maximum task volume on the right end of the common NTB channel chip, and so on.

In some embodiments of the present disclosure, the backup task execution module 400 is configured to respectively execute the backup task on left half-region storage controllers and right half-region storage controllers through an upper common NTB channel chip and a lower common NTB channel chip.

In some embodiments of the present disclosure, the apparatus may further include: an abnormality processing module, configured to: when one or more storage controllers are abnormal, perform fault analysis to obtain data processing tasks to be allocated and data backup tasks to be allocated; and allocate the data processing tasks to be allocated and the data backup tasks to be allocated to other storage controllers.

An embodiment of the present disclosure further provides a terminal device, referring to FIG. 6, FIG. 6 is a schematic structural diagram of a terminal device provided in some embodiments of the present disclosure, and the terminal device may include:
a memory, configured to store a computer program; and
a processor, configured to implement the steps of any method for data backup of multi-controller mentioned above when executing the computer program.

As shown in FIG. 6, it is a schematic diagram of a composition structure of the terminal device, and the terminal device may include a processor 10, a memory 11, a communication interface 12, and a communication bus 13. The processor 10, the memory 11 and the communication interface 12 communicate with each other via the communication bus 13.

In the embodiment of the present disclosure, the processor 10 may be a central processing unit (CPU), a specific application integrated circuit, a digital signal processor, a field programmable gate array or other programmable logic devices, etc.

The processor 10 may call a program stored in the memory 11, and specifically, the processor 10 may execute operations in the embodiments of a method for data backup of multi-controller.

The memory 11 is configured to store one or more programs, the program may include program codes, the program codes include a computer operation instruction, and in the embodiment of the present disclosure, the memory 11 at least stores a program for implementing the following functions:
acquiring a processor working state of a host end;
performing task volume evaluation calculation on each storage controller based on the processor working state, to obtain a task volume of each storage controller, wherein the number of all the storage controllers is greater than two, and two common NTB channel chips for unidirectional transmission are connected between all the storage controllers;
determining a corresponding data backup task volume of each storage controller based on the task volume of each storage controller and a data processing task volume of each storage controller; and
executing a backup task on corresponding storage controllers via the common NTB channel chips and the data backup task volume of each storage controller.

In some embodiments of the present disclosure, the memory 11 may include a program storage region and a data storage region, wherein the program storage region may store an operation system and an application program required for at least one function, and the like; and the data storage region may store data created in use.

In addition, the memory 11 may include a high-speed random access memory, and may further include a non-transitory memory, for example, at least one magnetic disk storage device or other volatile solid-state storage devices.

The communication interface 12 may be an interface of a communication module, and is configured to connect to other devices or systems.

Of course, it should be noted that the structure shown in FIG. 6 does not constitute a limitation to the terminal device in the embodiment of the present disclosure, and actual applications, the terminal device may include more or fewer components than those shown in FIG. 6, or combine some components.

Embodiments of the present disclosure further provide a computer non-transitory readable storage medium, wherein a computer program is stored on the computer non-transitory readable storage medium, and the computer program, when executed by a processor, may implement the steps of any method for data backup of multi-controller mentioned above.

The computer non-transitory readable storage medium may include any medium capable of storing program codes, such as a USB flash disk, a mobile hard disk, a read-only memory (ROM), a random access memory (RAM), a magnetic disk, or an optical disk.

For the description of the computer non-volatile readable storage medium provided in the embodiment of the present disclosure, reference may be made to the above method embodiments, and thus details are not repeated herein in the present disclosure.

The embodiments in the specification are described in a progressive manner, what is highlighted in each embodiment is difference with other embodiments, and the identical or similar parts between the embodiments refer to each other. The apparatus disclosed in the embodiments corresponds to the method disclosed in the embodiments, and thus is described simply, and reference may be made to the description of the method for related parts.

Those skilled in the art may further be aware that, the steps of units and algorithms of various examples described in combination with the embodiments disclosed in the present specification may be implemented by electronic hardware, computer software, or a combination thereof; and in order to clearly illustrate the interchangeability of hardware and software, the compositions and steps of the examples have been generally described in the above description in accordance with functions. Whether these functions are executed by hardware or software depends on particular applications and design constraint situations of the technical solutions. Those skilled in the art may use different methods to implement the described functions for each particular application, but it should not be considered that the implementation goes beyond the scope of the present disclosure.

The steps of methods and algorithms described in combination with the embodiments disclosed herein may be directly implemented by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

The method for data backup of multi-controller, the apparatus for data backup, the terminal device and the computer non-transitory readable storage medium provided in the present disclosure have been described in detail above. The principles and embodiments of the present disclosure are described herein by using specific examples, and the descriptions of the above embodiments are only used to help understand the method of the present disclosure and the core idea thereof. It should be noted that, for those ordinary skilled in the art, several improvements and modifications may also be made to the present disclosure without departing from the principles of the present disclosure, and these improvements and modifications also fall within the protection scope of the claims of the present disclosure.

### INDUSTRIAL APPLICABILITY

The technical solutions provided in the embodiments of the present disclosure are applicable to the technical field of computers. In the embodiments of the present disclosure, by means of first acquiring a processor working state of a host end, then determining a processable task volume of each storage controller based on the processor working state, determining a corresponding data backup task volume based on the task volume, and finally executing a backup task according to the determined data backup task volume, in a case where there are two NTB channel chips, the task volume of each storage controller is balanced, data backup is realized, and the efficiency of data backup is improved while the hardware cost is reduced.

1. A method for data backup of multi-controller, comprising:
acquiring a processor working state of a host end;
performing task volume evaluation calculation on each storage controller based on the processor working state, to obtain a task volume of each storage controller, wherein number of all the storage controllers is greater than two, and two common NTB channel chips for unidirectional transmission are connected between all storage controllers;
determining a corresponding data backup task volume of each storage controller based on the task volume of each storage controller and a data processing task volume of each storage controller; and
executing a backup task on the storage controllers via the common NTB channel chips and the data backup task volume of each storage controller.

2. The method for data backup as claimed in claim 1, wherein performing task volume evaluation calculation on each storage controller based on the processor working state, to obtain the task volume of each storage controller comprises:
performing weighted balance calculation on each storage controller based on the processor working state, to obtain the task volume of each storage controller.

3. The method for data backup as claimed in claim 2, wherein performing weighted balance calculation on each storage controller based on the processor working state, to obtain the task volume of each storage controller comprises:
determining parameters of data processing at a next time node based on the processor working state, wherein the parameters comprise a data volume, a data type, a data use, and a storage address;
using the data type, the data use and the storage address as weights, using the data volume as the parameter of each weight, and performing weighted calculation to obtain the task volume of each storage controller.

4. The method for data backup as claimed in claim 3, further comprising:
in response to that the task volume of each storage controller is obtained, respectively sorting the task volumes of the storage controllers on left and right ends of the common NTB channel chips.

5. The method for data backup as claimed in claim 1, wherein determining the corresponding data backup task volume of each storage controller based on the task volume of each storage controller and the data processing task volume of each storage controller comprises:
controlling a storage controller having the maximum task volume on the left end of the common NTB channel chip to issue a data backup task to a storage controller having the minimum task volume on the right end of the common NTB channel chip, and so on; and
controlling a storage controller having the minimum task volume on the left end of the common NTB channel chip to issue the data backup task to a storage controller having the maximum task volume on the right end of the common NTB channel chip, and so on.

6. The method for data backup as claimed in claim 1, further comprising:
in response to executing a data processing task and the data backup task, recording servers of the data processing task and the data backup task to obtain log data, and saving the log data.

7. The method for data backup as claimed in claim 1, wherein all the storage controllers are divided into left half-region storage controllers and right half-region storage controllers, and the two common NTB channel chips for unidirectional transmission comprise an upper common NTB channel chip and a lower common NTB channel chip;
a PCIE transport channel on each left half-region storage controller is connected with the upper common NTB channel chip for transporting data, and a PCIE receive channel on each right half-region storage controller is connected with the upper common NTB channel chip for receiving data; and the PCIE receive channel on each left half-region storage controller is connected with the lower common NTB channel chip for receiving data, and the PCIE transport channel on each right half-region storage controller is connected with the lower common NTB channel chip for transporting data.

8. The method for data backup as claimed in claim 7, wherein executing the backup task on the storage controllers via the common NTB channel chips and the data backup task volume of each storage controller comprises:
respectively executing the backup task on the left half-region storage controllers and the right half-region storage controllers via the upper common NTB channel chip and the lower common NTB channel chip.

9. The method for data backup as claimed in claim 1, further comprising:
in response to that one or more storage controllers are abnormal, performing fault analysis to obtain data processing tasks to be allocated and data backup tasks to be allocated; and allocating the data processing tasks to be allocated and the data backup tasks to be allocated to other storage controllers.

10. The method for data backup as claimed in claim 9, wherein in response to that one or more storage controllers are abnormal, performing fault analysis to obtain the data processing tasks to be allocated and the data backup tasks to be allocated comprises:
in response to that one or more storage controllers are abnormal, performing data feature extraction to obtain data features; and
performing fault analysis based on the data features to obtain the data processing tasks to be allocated and the data backup tasks to be allocated.

11. The method for data backup as claimed in claim 9, wherein allocating the data processing tasks to be allocated and the data backup tasks to be allocated to the other storage controllers comprises:
performing priority analysis on each data processing task to be allocated and each data backup task to be allocated, to obtain a priority of each task; and
allocating the data processing tasks to be allocated and the data backup tasks to be allocated to the other storage controllers based on the priority of each task.

12. A method for data backup of multi-controller, comprising: acquiring a processor working state of a host end;
determining a task volume of each storage controller based on the processor working state, wherein number of the storage controllers is greater than two, and two common NTB channel chips for unidirectional transmission are connected between all storage controllers; determining a data backup task volume corresponding to each storage controller based on the task volume of each storage controller and a data processing task volume of each storage controller; and
executing a backup task on the storage controllers according to a determined data backup task volume of each storage controller.

13. A storage control system, comprising: a plurality of storage controllers, two common NTB channel chips, and a hard disk,
wherein each common NTB channel chip is connected with a data channel of each storage controller, and each storage controller is connected with the hard disk; and
the common NTB channel chip is configured to, along with a data backup task volume of each storage controller, execute a backup task on the storage controllers.

14. The storage control system as claimed in claim 13, wherein there are even numbers of storage controllers, and the plurality of storage controllers comprise left half-region storage controllers and right half-region storage controllers.

15. The storage control system as claimed in claim 14, wherein the common NTB channel chips comprise an upper common NTB channel chip and a lower common NTB channel chip.

16. The storage control system as claimed in claim 15, wherein a PCIE transport channel on the left half-region storage controller is connected with the upper common NTB channel chip for transporting data, and a PCIE receive channel on the right half-region storage controller is connected with the upper common NTB channel chip for receiving data; and the PCIE receive channel on the left half-region storage controller is connected with the lower common NTB channel chip for receiving data, and the PCIE transport channel on the right half-region storage controller is connected with the lower common NTB channel chip for transporting data.

17. The storage control system as claimed in claim 16, wherein the upper common NTB channel chip executes the backup task on the left half-region storage controllers and the right half-region storage controllers; and
the lower common NTB channel chip executes the backup task on the left half-region storage controllers and the right half-region storage controllers.

18.-20. (canceled)

21. The method for data backup as claimed in claim 1, wherein the method further comprises:
recording fault information and task allocation situation information in a log manner.

22. The method for data backup as claimed in claim 1, wherein the number of storage controllers are even.

23. The method for data backup as claimed in claim 12, wherein determining the data backup task volume corresponding to each storage controller based on the task volume of each storage controller and the data processing task volume of each storage controller comprises:
controlling a storage controller having the maximum task volume on the left end of the common NTB channel chip to issue a data backup task to a storage controller having the minimum task volume on the right end of the common NTB channel chip, and so on; and
controlling a storage controller having the minimum task volume on the left end of the common NTB channel chip to issue the data backup task to a storage controller having the maximum task volume on the right end of the common NTB channel chip, and so on.
